(19) United States
(12) Patent Application Publication
(10) Pub. No.: US 2011/0016471 A1
(43) Pub. Date: Jan. 20, 2011

(54) Balancing Resource Allocations Based on Priority

(75) Inventors: Siddharth R. Shah, Bothell, WA (US); Mircea Neagovici-Negoescu, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/503,147

(22) Filed: Jul. 15, 2009

(51) Int. Cl. G06F 9/46; G06F 17/30

(52) U.S. Cl. 718/104; 707/E17.108

(57) ABSTRACT

Balancing resource allocations based on priority may be provided. First, a plurality of repositories may be divided into at least two categories. Next, a first portion of computing resources may be dedicated to a first one of the at least two categories. Then a second portion of the computing resources may be dedicated to a second one of the at least two categories. A crawl may then be performed on the plurality of repositories with the computing resources.

### BACKGROUND

A web crawler is a computer program that traverses the internet in an automated manner. The process of traversing the internet in a methodical, automated manner is called web crawling. Many sites, in particular search engines, use web crawling to provide current data for the search engine. Web crawlers are mainly used to create a copy of all visited pages for later processing by a search engine that will index the downloaded pages to provide fast searches.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Balancing resource allocations based on priority may be provided. First, a plurality of repositories may be divided into at least two categories. Next, a first portion of computing resources may be dedicated to a first one of the at least two categories. Then a second portion of the computing resources may be dedicated to a second one of the at least two categories. A crawl may then be performed on the plurality of repositories with the computing resources.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for balancing resource allocations based on priority; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Balancing resource allocations based on priority may be provided. A web crawler may comprise a computer program for traversing the internet or an intranet in a methodical manner. This process of traversing the internet or an intranet in a methodical, automated manner is called web crawling. Web crawling, for example, may comprise traversing a URL space to acquire items to record in a search catalog. Many sites, in particular search engines, may use web crawling to provide current data for the search engine. Web crawlers may be used to create a copy of visited pages for later processing by the search engine that may index the downloaded pages to provide fast searches.

The internet's or an intranet's large volume, fast change rate, and dynamic pages may make crawling difficult. For example, the internet's large volume may mean that the crawler can only download a fraction of the web pages on the internet within a given time. The fast change rate may mean that by the time the crawler has crawled a website, new pages may have been added to the crawled site. Consequently, the crawler may need to take into consideration certain priorities when it carries out the crawling process.

An indexer may comprise a computer program that performs a crawling function. A crawler may run a plurality of indexer. With conventional systems, during a crawl of repositories (e.g. websites,) the crawler assigns all indexer resources equally to all URL paths. Consistent with embodiments of the invention, however, more indexer resources may be allocated to maintain freshness of high-value repositories than to lower-value (normal) repositories. In other words, more resources (e.g. indexer) in the crawler may be dedicated to high-value repositories. Moreover, the indexer may comprise a physical machine that performs crawling functionality. Consistent with embodiments of the invention, a search system may run a plurality of indexers and consequently a plurality of crawlers. Furthermore a crawler may perform multiple functions, such as traversing URL paths, downloading items to index, pre-processing these items, and finally indexing the items to build an index. All of these functions may require computing resources that may be controlled and balanced by the crawler. Consistent with embodiments of the invention, this can be done according to a configuration set by an administrator.

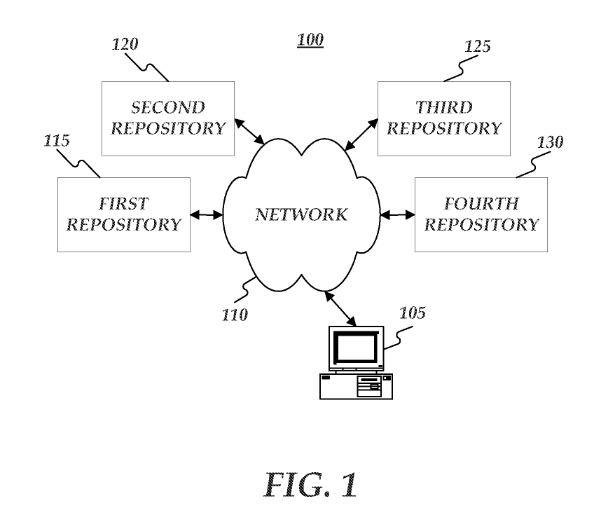

FIG. 1 is a block diagram of an operating environment including a resource allocation system 100. As shown in FIG. 1, system 100 may include a crawler 105, a network 110, a first repository 115, a second repository 120, a third repository 125, and a fourth repository 130. First repository 115, second repository 120, third repository 125, and fourth repository 130 may comprise websites located on network 110. While FIG. 1 shows four repositories, system 100 may include any number of repositories. Network 110 may comprise, but is not limited to, a local area network (LAN), a wide area network (WAN), an intranet, or the Internet, for example. As described in greater detail below, crawler 105 may be implemented using computing device 300. Crawler 105 may run a plurality of indexer (e.g. a plurality of indexer 321 as described below). Moreover, crawler 105 may comprise a server farm and may not be limited to one processing unit.

Consistent with embodiments of the invention, the plurality of indexer may be divided, for example, into two categories, one for high-value repositories and another for normal repositories. Search administrators, for example, may determine which repositories fall under which of the two categories. Whenever crawler 105 performs a crawl of a high-value repository, crawler 105 may provide dedicated resources from the plurality of indexer for that crawl. If there are no high-value repositories crawling, crawler 105 may release the dedicated resources from the plurality of indexer for consumption by all repositories. In other words, resources may be divided across different pools depending on priority of the crawl. Embodiments of the invention may include the dynamic re-division of resources based on what repositories are crawling at any given time.

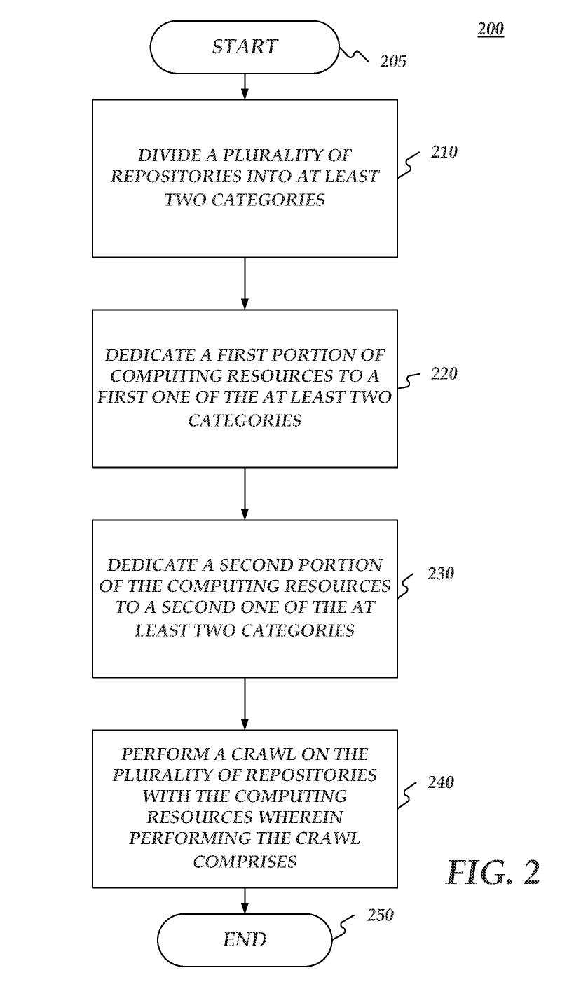

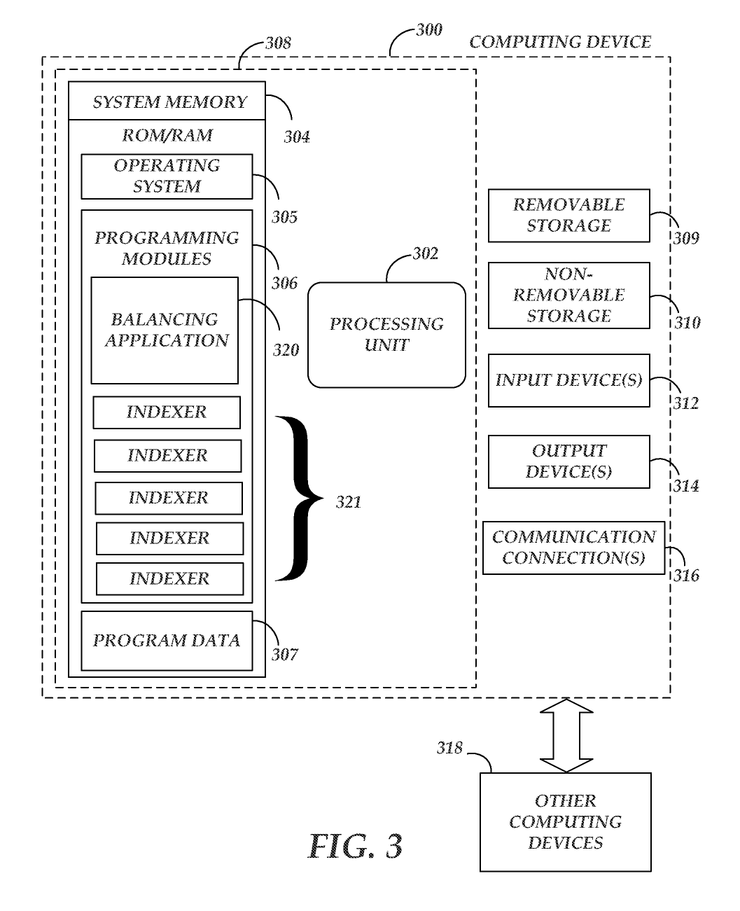

FIG. 2 is a flow chart setting forth the general stages involved in a method 200 consistent with an embodiment of the invention for balancing resource allocations. Method 200 may be implemented using a computing device 300 as described in more detail below with respect to FIG. 3. Ways to implement the stages of method 200 will be described in greater detail below.

Method 200 may begin at starting block 205 and proceed to stage 210 where crawler 105 may divide a plurality of repositories into at least two categories. For example, a first one of the at least two categories may comprise a category corresponding to high-value repositories and a second one of the at least two categories may comprise a category corresponding to normal repositories. High-value repositories may comprise repositories that should be crawled more often than normal repositories. High-value repositories, for example, may comprise repositories that should be crawled every 20 min. High-value repositories may be crawled more often (or with more resources) with the intent of keeping the content “fresher” compared to other repositories. Normal repositories, for example, may comprise repositories that should be crawled once per day. While two categories are described, embodiments of the invention may include any number of categories.

The plurality of repositories may comprise, for example, websites on network 110 (e.g. the internet or an intranet). For example, the plurality of repositories may comprise first repository 115, second repository 120, third repository 125, and fourth repository 130. First repository 115 and second repository 120 may be placed in the first one of the at least two categories. Third repository 125 and fourth repository 130 may be placed in the second one of the at least two categories. Crawler 105 may receive input from an administrator labeling which of the plurality of repositories comprise the first one of the at least two categories and which of the plurality of repositories comprise the second one of the at least two categories.

From stage 210, where crawler 105 divides the plurality of repositories into the at least two categories, method 200 may advance to stage 220 where crawler 105 may dedicate a first portion of computing resources to the first one of the at least two categories. For example, the computing resources may comprise plurality of indexers 321 as shown below with respect to FIG. 3. Each one of plurality of indexers 321 may comprise a computer program that performs a crawling function. Crawler 105, which may be implemented by computing device 300 that may run plurality of indexers 321. A first portion of plurality of indexers 321 may be dedicated to the first one of the at least two categories. For example, the first portion of plurality of indexers 321 may be dedicated to high-value repositories.

Once crawler 105 dedicates the first portion of computing resources to the first one of the at least two categories in stage 220, method 200 may continue to stage 230 where crawler 105 may dedicate a second portion of the computing resources to a second one of the at least two categories. A second portion of plurality of indexers 321 may be dedicated to the second one of the at least two categories. For example, the second portion of plurality of indexers 321 may be dedicated to normal repositories.

After crawler 105 dedicates the second portion of the computing resources to the second one of the at least two categories in stage 230, method 200 may proceed to stage 240 where crawler 105 may perform a crawl on the plurality of repositories with the computing resources. For example, crawler 105 may crawl repositories of the first one of the at least two categories with the first portion of the computing resources (e.g. first portion of plurality of indexers 321). At the same time, crawler 105 may crawl repositories of the second one of the at least two categories with the second portion of the computing resources (e.g. second portion of plurality of indexers 321). Consistent with embodiments of the inventions, because crawler 105 may complete the crawl of the repositories of the first one of the at least two categories before if completes the crawl of the repositories of the second one of the at least two categories, crawler 105 may release the first portion of the computing resources to crawl the second one of the at least two categories in addition to the second portion of the computing resources.

Consistent with embodiments of the invention more indexer resources may be allocated to maintain freshness of high-value repositories than to lower-value (normal) repositories. In other words, more resources (e.g. indexer) in the crawler may be dedicated to high-value repositories. Whenever crawler 105 performs the crawl of a high-value repository, crawler 105 may provide dedicated resources from plurality of indexer 321 for the crawl. If there are no high-value repositories crawling, crawler 105 may then release the dedicated resources from plurality of indexer 321 for consumption by all repositories. In other words, resources may be divided across different pools depending on priority of the crawl. Embodiments of the invention may include the dynamic re-division of resources based on what repositories are crawling at any given time. Once crawler 105 performs the crawl in stage 240, method 200 may then end at stage 250.

An embodiment consistent with the invention may comprise a system for balancing resource allocations. The system may comprise a memory storage and a processing unit coupled to the memory storage. The processing unit may be operative to divide a plurality of repositories into at least two categories. In addition, the processing unit may be operative to dedicate a first portion of computing resources to a first one of the at least two categories and to dedicate a second portion of the computing resources to a second one of the at least two categories. In addition, the processing unit may be operative to perform a crawl on the plurality of repositories with the computing resources. Performing the crawl may comprise: i) crawling repositories of the first one of the at least two categories with the first portion of the computing resources; ii) crawling repositories of the second one of the at least two categories with the second portion of the computing resources; and iii) crawling the repositories of the second one of the at least two categories with the first portion of computing resources when the crawl of the repositories of the first one of the at least two categories with the first portion of the computing resources is complete.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for crawler 105 as described above. Crawler 105 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 300's operation. In one embodiment, programming modules 306 may include, for example, balancing application 320, plurality of indexers 321. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. balancing application 320, plurality of indexers 321) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet or an intranet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for balancing resource allocations, the method comprising:
dividing a plurality of repositories into at least two categories;
dedicating a first portion of computing resources to a first one of the at least two categories;
dedicating a second portion of the computing resources to a second one of the at least two categories; and
performing a crawl on the plurality of repositories with the computing resources wherein performing the crawl comprises,
crawling repositories of the first one of the at least two categories with the first portion of the computing resources,
crawling repositories of the second one of the at least two categories with the second portion of the computing resources, and
crawling the repositories of the second one of the at least two categories with the first portion of computing resources when the crawl of the repositories of the first one of the at least two categories with the first portion of the computing resources is complete.

2. The method of claim 1, wherein dividing the plurality of repositories into the at least two categories comprises dividing the plurality of repositories into the at least two categories wherein the first one of the at least two categories comprises a category corresponding to a high-value repository.

3. The method of claim 1, wherein dividing the plurality of repositories into the at least two categories comprises dividing the plurality of repositories into the at least two categories wherein the second one of the at least two categories comprises a category corresponding to a normal repository.

4. The method of claim 1, wherein dividing the plurality of repositories into the at least two categories comprises dividing the plurality of repositories into the at least two categories based upon input from an administrator.

5. The method of claim 1, wherein dividing the plurality of repositories comprises dividing the plurality of repositories comprising a plurality of websites.

6. The method of claim 1, wherein dedicating the first portion of computing resources comprises dedicating the first portion of computing resources wherein the computing resources comprise a plurality of indexers.

7. A computer-readable medium that stores a set of instructions which when executed perform a method for balancing resource allocations, the method executed by the set of instructions comprising:
performing a crawl on a plurality of repositories with computing resources wherein performing the crawl comprises,
crawling repositories of a first one of at least two categories with a first portion of the computing resources,
crawling repositories of a second one of the at least two categories with a second portion of the computing resources, and
crawling the repositories of the second one of the at least two categories with the first portion of computing resources when the crawl of the repositories of the first one of the at least two categories with the first portion of the computing resources is complete.

8. The computer-readable medium of claim 7, further comprising dividing the plurality of repositories into at least two categories.

9. The computer-readable medium of claim 8, wherein dividing the plurality of repositories into the at least two categories comprises dividing the plurality of repositories into the at least two categories wherein the first one of the at least two categories comprises a category corresponding to a high-value repository.

10. The computer-readable medium of claim 8, wherein dividing the plurality of repositories into the at least two categories comprises dividing the plurality of repositories into the at least two categories wherein the second one of the at least two categories comprises a category corresponding to a normal repository.

11. The computer-readable medium of claim 8, wherein dividing the plurality of repositories into the at least two categories comprises dividing the plurality of repositories into the at least two categories based upon input from an administrator.

12. The computer-readable medium of claim 8, wherein dividing the plurality of repositories comprises dividing the plurality of repositories comprising a plurality of websites.

13. The computer-readable medium of claim 7, further comprising dedicating the first portion of computing resources to the first one of the at least two categories.

14. The computer-readable medium of claim 13, wherein dedicating the first portion of computing resources comprises dedicating the first portion of computing resources wherein the computing resources comprise a plurality of indexers.

15. The computer-readable medium of claim 7, further comprising dedicating the second portion of the computing resources to the second one of the at least two categories.

16. A system for balancing resource allocations, the system comprising:
a memory storage; and
a processing unit coupled to the memory storage, wherein the processing unit is operative to:
divide a plurality of repositories into at least two categories;
dedicate a first portion of indexers to a first one of the at least two categories;
dedicate a second portion of the indexers to a second one of the at least two categories; and
perform a crawl on the plurality of repositories with the indexers wherein the processing unit being operative to perform the crawl comprises the processing unit being operative to,
crawl repositories of the first one of the at least two categories with the first portion of the indexers,
crawl repositories of the second one of the at least two categories with the second portion of the indexers, and
crawl the repositories of the second one of the at least two categories with the first portion of indexers when the crawl of the repositories of the first one of the at least two categories with the first portion of the indexers is complete.

17. The system of claim 16, wherein the processing unit being operative to divide the plurality of repositories into the at least two categories comprises the processing unit being operative to divide the plurality of repositories into the at least two categories wherein the first one of the at least two categories comprises a category corresponding to a high-value repository.

18. The system of claim 16, wherein the processing unit being operative to divide the plurality of repositories into the at least two categories comprises the processing unit being operative to divide the plurality of repositories into the at least two categories wherein the second one of the at least two categories comprises a category corresponding to a normal repository.

19. The system of claim 16, wherein the processing unit being operative to divide the plurality of repositories into the at least two categories comprises the processing unit being operative to divide the plurality of repositories into the at least two categories based upon input from an administrator.

20. The system of claim 16, wherein the processing unit being operative to divide the plurality of repositories comprises the processing unit being operative to divide the plurality of repositories comprising a plurality of websites.
